(19) United States
(12) Patent Application Publication
(10) Pub. No.: US 2003/0078821 A1
(43) Pub. Date: Apr. 24, 2003

(54) System and method for identifying individuals having a desired skill set

(76) Inventors: Ravi Srinath Gorur, Centreville, VA (US); David Leslie, Great Falls, VA (US); Roderick Peter Silton, Herndon, VA (US); Michael Baker Yost, Great Falls, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/073,151

(22) Filed: Feb. 13, 2002

Related U.S. Application Data
(60) Provisional application No. 60/325,195, filed on Sep. 28, 2001.
(60) Provisional application No. 60/325,218, filed on Sep. 28, 2001.
(60) Provisional application No. 60/325,194, filed on Sep. 28, 2001.

(51) Int. Cl. G06F 17/60

(52) U.S. Cl. 705/7

(57) ABSTRACT

A system and method for producing an employee yellow pages is disclosed. The employee yellow pages is based in part on information that is generated through the participation of individuals in a collaborative work environment.

The present application claims priority to Provisional Application No. 60/325,195, entitled “SYSTEM AND METHOD FOR IDENTIFYING INDIVIDUALS HAVING A DESIRED SKILL SET,” filed Sep. 29, 2001, Provisional Application No. 60/325,218, entitled “SYSTEM AND METHOD FOR IMPROVING COLLABORATION BETWEEN ENTITIES IN A WORK ENVIRONMENT,” filed Sep. 29, 2001, and Provisional Application No. 60/325,194, entitled “SYSTEM AND METHOD FOR IMPROVING OPERATIONAL EFFICIENCY THROUGH PROCESS AUTOMATION” filed Sep. 29, 2001, each of which is incorporated herein by reference in its entirety.

### CROSS-REFERENCE TO OTHER APPLICATIONS

The following applications of common assignee contain some common disclosure, and are believed to have an effective filing date identical with that of the present application.

“System and Method for Improving Management in a Work Environment,” Attorney Docket No. INST002/01US, application Ser. No. ______, incorporated herein by reference in its entirety.

“System and Method for Improving Operational Efficiency Through Process Automation,” Attorney Docket No. INST003/01US, application Ser. No. ______, incorporated herein by reference in its entirety.

### BACKGROUND

1. Field of the Invention

The present invention relates generally to enterprise management, and more specifically to a system and method for leveraging information generated in a collaborative work environment.

2. Discussion of the Related Art

Organizations are comprised of a wide range of individuals, each possessing a unique skill set. An individual's skill set is typically scrutinized prior to entering into an organization. During the interviewing and candidate-examination process, the individual's skills are assessed relative to a need within the organization. The organization's need can be generally stated or can be specifically defined by a detailed job description. If the individual's skills match the organization's need, then the individual's chances for being hired are enhanced.

Typically, the organization's assessment of the candidate relies primarily on the candidate's resume. The resume is a self-generated profile of the candidate and is ideally targeted to the position that the candidate seeks. In other words, the candidate's resume should detail the skills and experiences of the candidate that are directly relevant to the responsibilities of the desired position. Details of the skills and experiences of the candidate that are not relevant to the responsibilities of the desired position are typically left unmentioned.

Notwithstanding the extent of the individual's skills upon entering into an organization, the organization will typically provide the individual with the appropriate training to ensure that the individual is well equipped to contribute to the organization. Training is a vital part of the organization's investment in its employees. In many cases, an organization will not recoup its total investment in the individual until the individual has worked within the organization for a few years.

As the individual progresses through the years of employment, the individual's skills will often be enhanced in a variety of ways. Individuals benefit from informal/formal training programs that enhance existing skills or teach new sets of skills. Individuals can also enhance their skill sets by their own individual studies. Regardless of the basis for the creation of new skills, an individual's skill set will continually evolve. An organization is therefore comprised of a collection of individuals having dynamically changing skill sets.

Organizations are constantly looking to extract the maximum value out of its employees. Notwithstanding efforts to improve work efficiency, the organization should ensure that the skill sets available within the organization are being put to productive use. If valuable skill sets are left untapped, an organization cannot expect to leverage the full value of its employees. In other words, the maximum value of the individual to the organization can be realized only through an efficient allocation of the individual to one or more of the available tasks. This allocation problem is especially crucial in organizations that rely on the cooperation of teams of individuals. For example, consider the allocation problem within an engineering organization.

Engineers often face development challenges previously addressed by others in the organization. Ideally, team leaders would staff new projects with engineers having the optimal mix of skills. An inability to quickly identify the right set of individuals for a project can lead to inefficiencies and “reinventing the wheel.” Ultimately, a failure to leverage the skill sets of individuals within the organization results in a longer development process.

Conventionally, organizations publish a “white pages” directory that lists the employees within the various work groups. The designation of an individual's work group provides the primary description of the potential skills of an individual. These designations do not provide the best mechanism to search for potential candidates.

Alternatively, an organization may require individuals to prepare self-profiles. These self-profiles can be used internally to provide a more detailed description of a user's background and current work focus. Self-profiles are typically deficient as a vehicle for providing an accurate assessment of individual skill sets because self-profiles are reflective of a self-assessment of the skills that are deemed “valuable.” Like a personal resume, a self-profile inevitably emphasizes and de-emphasizes particular skills. In general, self-assessments rarely capture the true extent of an individual's skills.

Even if an individual has prepared an accurate initial self-profile, the self-profile will not accurately portray an individual's skills as they are enhanced over time. Individuals are not typically motivated to continually update self-profiles, especially when the perceived value of the self-profile update is fairly low. Quite often, an engineer would view the self-profile as not being “worth his time.”

As would be appreciated, the failure to fully leverage an organization's employees can lead to an organization's loss in productivity and competitiveness. In many cases, unique and rare skills will be lost to the organization. What is needed therefore is a mechanism that enables the organization to leverage the collective skills within the organization without requiring extensive effort on the part of the employees.

### SUMMARY

The present invention addresses the aforementioned needs by providing a mechanism for producing an employee yellow pages. In accordance with the present invention, the employee yellow pages is based in part on information that is generated through the participation of individuals in a collaborative work environment.

### BRIEF DESCRIPTION OF THE DRAWINGS

FIG. 1 is a network diagram illustrating a work collaboration system.

FIG. 2 is a workflow process.

FIG. 3 is a hierarchical organization of activities.

FIG. 4 is a flow chart for identifying individuals that have a desired skill set.

### DETAILED DESCRIPTION

An embodiment of the invention is discussed in detail below. While specific implementations are discussed, it should be understood that this is done for illustration purposes only. A person skilled in the relevant art will recognize that other components and configurations may be used without departing from the spirit and scope of the invention.

Organizations have wrestled with the continuing problem of ensuring the proper allocation of individuals to various projects and tasks. As the organization evolves, it is often difficult to generate an accurate view of the capabilities of the individuals within the various groups. Reorganizations, training, and general professional development each contribute to a changing skills landscape within the organization.

Managers are especially handicapped by an organization's inability to assess its own resources. Project staffing is often based on a pool of people with which the manager has developed some familiarity. If a required skill does not exist within the collective skill set of the pool of people, then the manager is often left to designate an individual to acquire the needed skill. While the addition of the skill to the designated individual's skill set is beneficial to the individual, the organization as a whole suffers. For example, an individual having the needed skill may be underutilized, or the time to acquire the skill may introduce an unnecessary and critical delay into the project deliverable. Human resource utilization is therefore a critical element to an organization's success. Maintaining visibility into this evolving resource represents a significant challenge.

In accordance with the present invention, a system is provided that enables an organization to acquire an improved visibility into the current capabilities of the individuals within the organization. This improved visibility enables managers to identify individuals that are well suited for the available tasks at hand. As will be described in greater detail below, skill sets for the available individuals can be identified by leveraging an activity database that includes information on the various tasks or projects with which the various individuals have been involved. Based on this activity database, an employee “yellow pages” can be generated that enables users to locate individuals having a particular skill, competency, background, or prior experience.

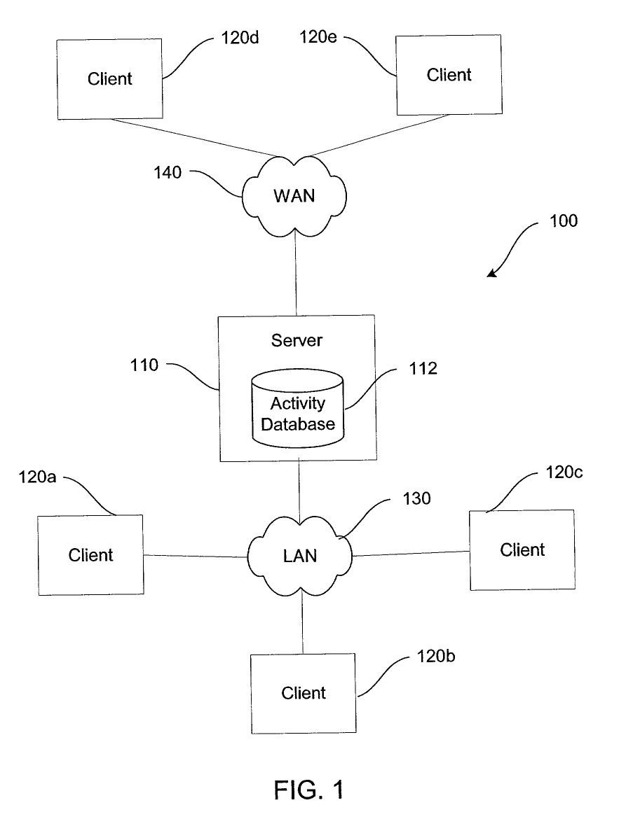

FIG. 1 illustrates an example environment in which the principles of the present invention can be applied. As illustrated, system environment 100 includes a server 110 that communicates with clients 120a, 120b, 120c via local area network (LAN) 130, and with clients 120d, 120e via wide area network (WAN) 140. One example of a WAN is the Internet. As would be appreciated through the following description, the principles of the present invention can be applied to various implementations of LAN 130 and WAN 140, which provide a communications infrastructure for system environment 100. This communications infrastructure enables users operating on one or more of clients 120a-120e to collaborate in a work environment.

Collaboration within the work environment can be accomplished in a variety of ways. For example, collaboration can be based on a common electronic workspace that enables information sharing between a plurality of users at a corresponding plurality of clients 120a-120e. Here, the information sharing can be open or restricted depending upon the nature of the information being shared. In another example, collaboration can be based on communications between individualized workspaces. In this scenario, communications can represent instructions, alerts, status updates, project/task changes, etc. among users operating within system environment 100.

Regardless of the particular form of collaboration within the organization, a database of information reflective of organization activity can be generated. In the illustrated embodiment of FIG. 1, the database is illustrated as centralized activity database 112. Activity database 112 is accessible by server 110. As would be appreciated, in other embodiments, the organization activity information can be distributed across multiple activity databases.

In general, the collection of activity information represents a resource that contains information on the collective experiences of individuals within the organization. This information collection can be mined to identify individuals within the organization that have a particular skill or set of skills. It is a feature of the present invention that the database of activity information to be mined can be continually updated with information reflective of activities within the organization. In this manner, the database of activity information can be used to provide the most up-to-date assessment of skills within the organization.

As will be described below in the context of an example embodiment, it is an additional feature of the present invention that the process of updating the activity database can occur automatically. This automatic process is significant because it does not rely on the efforts of the various users to update the database. In many instances, users will often resist generating or updating their own self-profile information due to the low perceived benefit. In general, employees will typically view the update process as an insignificant part of their job. Even if employees choose to generate or update their self-profile information, the results are often skewed by their own self-assessment. This effectively results in a loss of skills to the organization.

As noted, it is preferred that the activity database be updated with a minimal amount of effort by the employees. Accordingly, in one embodiment, activity database records are generated in the context of an automated enterprise management system that enables the assignment, monitoring, and/or managing of the completion of activities. In this manner, activity database 112 is updated through the natural usage of the enterprise management system.

In general, an activity record in activity database 112 is used to record information relating to an activity within the organization. In particular, the activity record in activity database 112 can include information relating to any activity that is relevant to the assessment of an individual's skills or qualifications. In one example, the activity can represent work performed within an organization, while in another example, the activity can represent an individual's participation in some form of training program. In yet another example, the activity can represent an individual's self-study or investigation efforts. In the example described below, an embodiment of work-related activity records is provided. As would be appreciated, work-related activity records often represent the dominant form of skill acquisition within the organization.

In an enterprise management system, varying work-related activities can be defined. In one embodiment, project, summary task, task, and workflow activities can be defined. A project activity is an association of activities that are focused on completing some objective. Projects do not have work associated with them directly but are the incorporation of several smaller units of work. Projects can be larger in scale and have some corporate visibility associated with them. Summary tasks are similar to projects as they represent a collection of smaller activities. Summary tasks generally do not have corporate visibility but they are used to summarize work in progress. Tasks are the smallest unit of activity and represent the building blocks of projects and summary tasks. Finally, workflow activities represent activities that have pre-defined workflows and processes associated with them.

In one embodiment, an activity object can be defined with the attributes identified in Table 1 below. Particular types of activity objects (i.e., project, summary task, task, and workflow activity objects) can use all or part of the set of attributes in Table 1. In various embodiment, values for the listed attributes can be manually set or automatically determined by the system.

TABLE 1

| Field Name | Description |
|---|---|
| Name | Title of the Activity |
| Description | Text that further details the activity |
| Duration | The number of work days required to complete |
| | an activity |
| Effort | Number of hours expected to complete the activity |
| Due Date | The expected completion date of the activity |
| Start Date | The date work is to begin on an activity. |
| End Date | The system determined end date of an activity |
| Date Calculation | Indicates how Start and End Dates are Calculated. |
| Mode | |
| Percent Complete | Percentage of activity work completed |
| Percent Complete | The user entered representation of the method used |
| Calculation Mode | to calculate percent complete for this activity |
| Priority | The emphasis placed on completion of this activity |
| | (e.g., high, medium, low) |
| Confidence Level | The likelihood that a user believes the activity will |
| | be completed on time (e.g., high, medium, low) |
| Activity State | The current workability of the activity (e.g., |
| | blocked, ready, issue, active, completed, abandoned) |
| Yellow Page Index | Skills Keyword |
| Activity Status | The overall health of the activity (e.g., on time, |
| | possible slip, late) |
| Dialog | Persistent Message Forum |

In general, the set of attributes enables an activity to operate in the context of an enterprise management system. For example, the Name, Description, Due Date, and Start Date attributes provide the basic parameters for the activity. These basic parameters define the type and amount of work to be assigned as well as the relevant scheduling for completion of the activity.

The set of attributes also includes attributes that enable the enterprise management system to track the status of an ongoing activity. This status information may be crucial to the operation of an organization. Status information provides interested parties with visibility into ongoing activities and enables the interested parties to plan accordingly when unexpected changes occur. Status information can therefore enable resource allocation functions. In general, resource allocation can be viewed as the process of assigning and tracking activities performed by individuals. Resource allocation can provides the basis of the entire scheduling and tracking process. In one embodiment, status information can be provided to interested parties through various channels (e.g., email) immediately upon the occurrence of particular events.

One example of status information is provided by the percent complete attribute. In one embodiment, the value of the percent complete attribute can be estimated by the individual. In other embodiments, the percent complete attribute is determined by the system, for example, by comparing the number of hours currently worked to the number of hours estimated to complete the activity. If the activity includes a collection of other activities (i.e., child activities), then the value of the percent complete attribute can be based on some form of aggregation of the percent complete attribute of each of the child activities.

In other examples, status information can also be provided through the use of the Confidence Level, Activity State and Activity Status attribute.

In the illustrated embodiment of Table 1, activity objects can also have a yellow page index attribute. The yellow page index attribute can include a list of competency keywords that are associated with an activity. The list of competency keywords represents one method of inferring skills of individuals that are associated with particular activities within an organization. The use of this attribute in the generation of an employee “yellow pages” is described in greater detail below.

As would be appreciated, activity objects can be used in a variety of ways in the context of a particular enterprise management system. In one example, activity objects can be used in the assignment of work amongst individuals within the organization. Here, a task activity object can be created by a first individual (e.g., manager) and assigned to a second individual. The task object can then be represented by an icon that is displayed in a task manager user interface. Assignment of task objects within the organization can therefore improve the efficiency and tracking of work within the organization.

Relationships between activity objects also provide significant management functionality. First, activities can function in accordance with a predecessor/successor relationship. Predecessor/successor relationships provide scheduling order to the completion of work. In this framework, the predecessor/successor relationship provides a mechanism to make one activity dependent on the completion of another activity. These relationships can be used to define workflow processes among a set of activity objects. Through the tracking of status information for the set of activity objects, workflow planning and management of organization activities can be achieved.

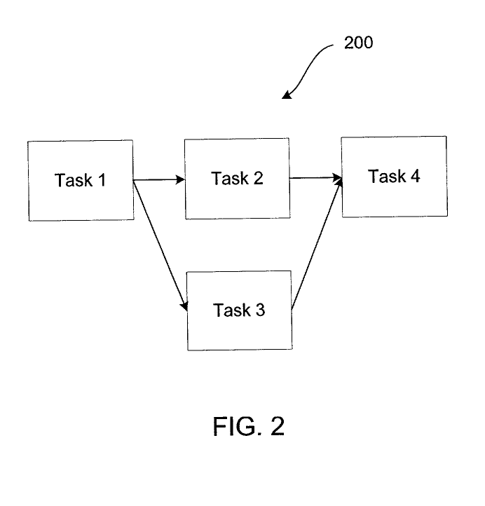

Consider for example, the workflow illustrated in FIG. 2. Workflow 200 includes four tasks that are arranged in a predecessor/successor relationship. As illustrated, task 2 and task 3 follow task 1, while task 4 follows task 2 and task 3. In an enterprise management system, the completion of tasks 1-4 can be coordinated through the management of status information amongst the individual tasks. For example, if the status of task 1 is unexpectedly changed, the ripple effects on tasks 2-4 can be accommodated through the notification of parties associated with affected tasks. Resource allocation within the organization as a whole can therefore be achieved. As would be appreciated, workflow 200 can be implemented and operated in the context of a user interface that is accessible to all or part of the organization. Visibility into the completion of various activities is therefore improved across the organization.

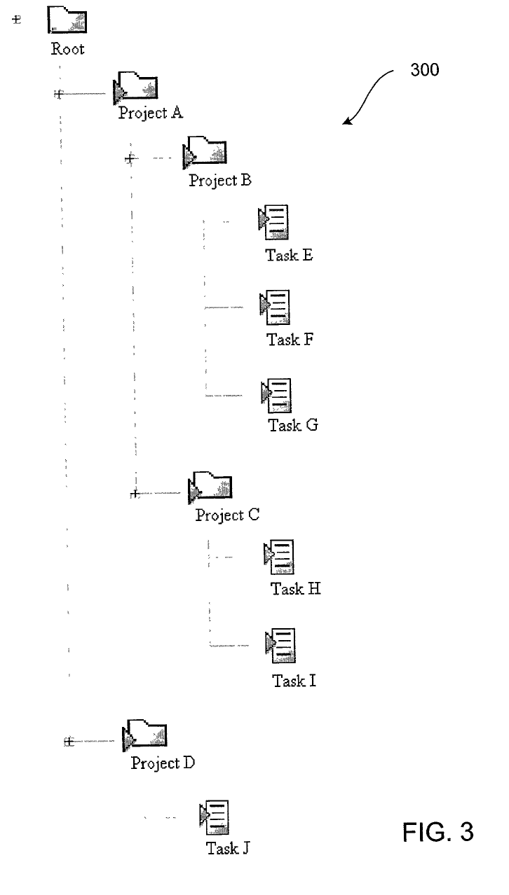

Activity objects can also be related in a hierarchical relationship. For example, consider the organization illustrated in user interface 300 of FIG. 3, which illustrates the relationship between activity objects. In the illustrated example, the Root node includes Projects A and D. Project A includes projects B and C, which further include tasks E-G and H-I, respectively. Project D further includes task J.

As would be appreciated, this hierarchy of activity objects enables an enterprise management system to organize the efforts within the organization, thereby increasing operational efficiency. In one embodiment, user interface 300 is accessible by the relevant portion of the organization. Information on particular projects or tasks can be obtained by the selection of a particular project or task icon.

In the preceding description, examples of possible enterprise management system components have been described. These example components are not intended to be exhaustive. Rather, the principles of the present invention can be applied to any form of collaborative environment that can be used to generate and store information that is descriptive, directly or indirectly, of work that is performed within the organization.

In the context of the present descriptive example, the descriptions of the work being performed within the organization is provided through the use of activity objects. As described above, these activity objects can have various attributes that provide some quantum of information about the work with which it is associated. As the information that is obtainable through the activity objects is representative of ongoing work in the organization, the information can be leveraged to produce an updateable description of the state of the organization.

As noted above, an important measure of the state of the organization is the current set of skills of the individuals within the organization. Over time, these skill sets evolve as the various individuals are exposed to, and benefit from, new work experiences. For some individuals, a wide variety of skills are developed. For others, true expertise in a particular skill is gained over time. Regardless of the type and depth of skill that is available, it is important for the organization to be able to leverage the skills at hand. Identification of the proper individual for a particular activity is a key component of a successful personnel-leveraging program.

In accordance with the present invention, individuals are identified through a search of records contained in activity database 112. In accordance with the embodiment described above, the records in activity database 112 represent activity objects having the attributes of Table 1. More generally, however, the records in activity database 112 can be embodied in any form that enables a direct or indirect description of past and ongoing work within the organization.

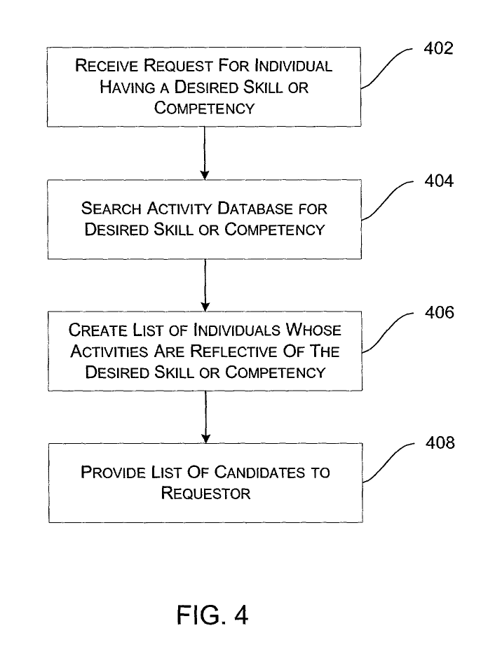

The process of identifying individuals having particular skill sets is illustrated in the flow chart of FIG. 4. The process begins at step 402 where a request for a desired skill or competency is received. In a typical scenario, this request may be prompted due to the projected staffing need for a particular activity (e.g., project, task, etc.). Here, a project-planning manager may assess the scope of the activity and recognize the need for a particular skill set that is unavailable in his current group. Conventionally, if the possible candidates aren't readily known to the manager, then the manager may be forced to have a member of his group acquire the needed skill. An unnecessary duplication of skills within the organization would therefore result.

In accordance with the present invention, individuals having needed skills can be identified through a search of a database that contains information reflective of work that has been or is currently being performed by the organization. This search can be launched through a user interface that allows the user to specify the desired skill. For example, a user could request a general search for all individuals within the organization that have experience in JavaScript or C++ programming.

In one embodiment, the content of the request is defined entirely by the user. Here, the user would not be limited in the specification of the request, thereby enabling any skill or competency to be searched. In another embodiment, where a set of known or popular skills or competencies can be predefined, a user interface can be defined that enables the user to select a skill from an enumerated list of pre-defined choices. As would be appreciated, both embodiments can be incorporated into a particular search-request user interface.

In addition to the specification of a skill, the request may also provide further qualifications on the desired skill. For example, the user can be permitted to further specify that the candidate individual has an expert, average, or novice rating in the desired skill. This skill or competency rating can be used by a manager to ensure that the candidate individual is neither over-qualified nor under-qualified for the particular activity at hand. In another example, a skill qualifier such as a measure of how recent the skill has been used or acquired can be provided in the request. As would be appreciated, the examples provided are not intended to be exhaustive. Further skill qualifiers can be defined in the context of a particular organization and application.

After the request has been specified, a search for candidate individuals can be initiated at step 404. As noted, it is a feature of the present invention that the search for candidate individuals is based on information reflective of the current state of the organization. A primary focus of this search is activity database 112, which contains information reflective of work that has been performed, or currently being performed, within the organization.

It should be noted, however, that the information in activity database 112 need not be the sole source of information. In one embodiment, the search can also cover information that represents an individual's background prior to association with the organization. This background information can be obtained through a skills-assessment survey, resume, etc. This captured information represents a base point in an individual's collection of skills. As new experiences are gained during an individual's time with the organization, the individual's skills will inevitably be extended.

At this point it should be noted that, by itself, the information obtained through a self-prepared/updated skills summary is typically an unreliable basis to gain an accurate view of an individual's skills. Self-profiles are typically reflective of a self-assessment of the skills that the individual deems “valuable.” Thus, a self-profile inevitably emphasizes and de-emphasizes particular skills.

In general, self-profile information may be necessary, but is certainly not sufficient, to generate an accurate view into the state of an organization. Thus, in one embodiment, self-profile information is acquired from the individuals and used as one element in the skill-set analysis of the organization. As such, the self-profile information can represent one additional component of the skill or competency search.

The skill-search process at step 404 can be implemented in a variety of ways. In one embodiment, the search process is based on skill keywords. For example, consider the framework described in the embodiment of Table 1, which illustrates various attributes of an activity object. One of the attributes is a yellow page index attribute. As noted, the yellow page index attribute can include a generalized graph (e.g., tree or list) of skill or competency keywords (e.g., JavaScript, C++, etc.) that are associated with an activity.

In performing a skill search in activity database 112, a search or query of the yellow page index attributes of the various activity objects in activity database 112 can be performed. This embodiment would obviate the need for the other attributes of the activity objects to be searched, thereby increasing the speed and efficiency of the search. Further, in one embodiment, the collection of yellow page index keywords can be used to populate a selectable list of skills or competencies that can be offered to a user when preparing a skill search.

In an alternative embodiment, the search through activity database 112 and self-profile database can be based on a search engine such as RetrievalWare® by Convera Corporation. In this embodiment, the entire content of activity database 112 and the self-profile database can be searched. For example, instead of focusing solely on keywords within the yellow page index attribute of an activity object, the search engine can also search through the description attribute of the activity object. The search through the description attribute of the activity object will frequently provide a more comprehensive view of the true extent of the associated activity, thereby providing a more accurate view into the comprehensive set of skills that may be involved.

As thus described, the searching process can be based on the raw records of activity database 112 or the self-profile database. In another embodiment, the searching process of step 404 can also be based on a metadatabase of information that has been generated from the raw database.

The content of the metadatabase is application specific and can be designed for the needs and focus of a particular organization. In general, the metadatabase can be used in situations where needed skill information is not readily ascertainable from the raw database records. In this situation, needed skill information is extracted prior to a skill search. As would be appreciated, the existence of the metadatabase does not necessarily preclude the performance of a search through the raw database itself.

In one example, the metadatabase of information can be generated on an activity record basis, thereby supplementing the information contained within the activity records. Here, the contents of a particular activity record can be analyzed to determine whether information on a skill can be inferred. For example, an individual's length of participation in an activity may be used to qualify the extent of the individual's experience in that particular skill. If the individual's participation is for a few days, then the individual has likely gained only a minimal amount of experience in that skill. On the other hand, if the individual's participation is for a few weeks, then the individual has likely gained a significant amount of experience in that skill. The qualifier on the level of skill obtained by the individual in that activity can then be generated and stored in the metadatabase of information.

In another example, the metadatabase of information can be generated on an individual basis. Here, the contents of a plurality of activity records associated with an individual can be analyzed together to determine whether information on a skill or competency can be inferred. For example, assume that an individual has participated in five activities that each required a brief use of a particular skill. On an individual activity record basis, none of the activity records would suggest that the individual had acquired significant experience in that skill. Analysis of the collection of activity records, however, may enable the inference that the individual has gained significant experience in that particular skill.

As would be appreciated, analysis of the raw databases of activity and self-profile information can be analyzed to varying degrees to extract needed information. This data mining process enables extraction of data based on an organization's particular goals. In general, the data mining process can be used to evaluate trends and relationships in the underlying raw database content.

It should also be noted that particular extraction methodologies can also be built into search engines that provide sophisticated query mechanisms. These search engines enable customization of the process of analyzing the raw database. In general, however, it is envisioned that the metadatabase of information will be created when needed skill or competency information is not easily retrievable from the raw database.

An advantage of the creation of a metadatabase is the speed at which the information is made available to the users. Once the organization has identified the type of information to be extracted and the methodology of doing so, the metadatabase of information can be created and automatically updated. The metadatabase of information need not be created upon the request of a particular user. The need for the information has already been anticipated and is therefore made available prior to user searches. When a user search is received, the search can then be processed by analyzing the contents of the metadatabase. It should be noted that the metadatabase can also be supplemented through the manual addition of further competency-related information (e.g., ratings or other qualitative information).

As noted, metadatabase information can be generated to address the general question of inferring competency-related information from an activity record. The need for accuracy in this inference can be significant when dealing with situations where multiple individuals are associated with a single activity. Whether the activity has one or more associated competencies, the question of individual attribution to the one or more associated competencies remains. Thus, a mechanism for controlling the attribution of competencies to activity participants is needed.

In one embodiment, activity participants can gain credit toward a competency based on the effort that they were assigned. For example, assume that a manager creates an activity that is listed as taking 80 hours and assigns it to John. The activity is also listed as having two competencies Circuit Design and Board Layout. Upon completion of the activity, John would gain credit for 40 hours for each competency.

The manager could also indicate some relative level or ratio for the two competencies. For example, the manager may indicate that most of the effort on this activity was related to Circuit Design (75%) and less toward Board Layout (25%). Thus, upon completion of the activity, John would receive 60 hours of credit toward Circuit Design and 20 hours of credit toward Board Layout.

In one embodiment, the manager could also indicate that different competencies are assigned to different activity participants. Thus if both John and Fred were assigned to the activity, John being responsible for the Circuit Design and Fred being responsible for the Board Layout, then John would get 40 hours of credit for Circuit Design and Fred would get 40 hours of credit for Board Layout, assuming that the two competencies are assigned equal weightings.

As noted, the relative hours of credit for the two competencies can also be adjusted. Thus, if most of the effort on this activity was related to Circuit Design (75%) and less toward Board Layout (25%), then John would get 60 hours of credit for Circuit Design and Fred would get 20 hours of credit for Board Layout.

More generally, competencies and associated weightings can be identified for each activity participant. Upon completion of the activity, the activity participant will gain a percentage of his total assigned hours for each identified competency. For example John may have a competency profile such that he is credited with both Circuit Design and Antenna Design with a ratio of 75:25. Then if he is assigned to 40 hours on activity X he will gain 30 hours towards Circuit Design and 10 hours towards Antenna Design. In various embodiments, an activity participant's competency profile can be set and/or by either the activity participant or the creator of the activity.

In one embodiment, a competency profile can be defined for a system role. Roles are a mechanism to assign work items and automation actions to users indirectly. Roles are useful to help convey responsibility, and ease automation configuration. Roles are significant in that they may be assigned as participants to activities and then resolved to an actual user independently within various scopes of the organization. In this framework, whenever the role is assigned to an activity then the user who resolves that role will gain credit for the competencies listed toward the role.

Further efficiencies in the assignment of competencies to activities can be gained through relationships between activities. In one embodiment, the system can be configured to allow competency assignments to propagate down the activity hierarchy. For example, if a certain summary task was configured with a Circuit Design competency, then all of the children of that summary task could automatically include that competency.

Additionally, the system can be configured to selectively configure the competencies on a user-selected set of activities. In one embodiment, a user may select five unrelated activities using the activity tree and assign a Board Layout competency to all of the activities in one step.

As described, the process of identifying individuals having needed skills or competencies can be implemented in a variety of ways. The search can be performed on a raw database of information and/or on a metadatabase of information. Standard database queries as well as search engine technology can also be used. Regardless of the type of search and analysis that is selected, it is significant that the search is based on information that, by its nature, can reasonably approximate the changing landscape of skills within the organization. Therefore, the principles of the present invention are not limited by the particular activity record format and content or the process of accessing and searching the activity records.

After the search has been completed, at step 406, a list of individuals having the desired skill or competency is compiled. This list presents the various candidate individuals that have been determined to be relevant to the needed type of experience. This list is analogous to a telephone yellow pages, which groups listings by the subject matter that is being investigated.

In various embodiments, the list of individuals can be provided in a ranked or unranked form. For example, if the target search is designed to infer the closeness of the match between individuals and the requested search, then a ranked list of individuals can be provided to the requestor.

At step 408, the compiled list of candidate individuals is provided to the requester. In one embodiment, the compiled list is provided as part of a user interface that enables the requestor to obtain contact information as well as the relevant experiences of the candidate individual. In one embodiment, the relevant experiences are provided to the requestor using links to the relevant activity objects. As the requestor is often unfamiliar with the candidate individuals, the additional candidate information will enable the requestor to determine the true relevance of the candidate.

In one embodiment, the compiled list can also be designed to include additional candidate information such as performance ratings or schedule availability. Performance ratings can be generated based on the completion/status information available for the relevant activity objects with which the candidate was or is involved. Availability information can be generated based on the current and future commitments that are expressed in the relevant activity objects with which the candidate is or will be involved. In general, the compiled list can be designed to include any additional relevant information that is obtainable from the enterprise management system.

Through the search and analysis process, the requestor is able to extend his horizon in identifying a set of candidate individuals. If the skill is available within the organization, then the relevant individuals are brought to the requestor's attention. Needed skills are therefore made available throughout the organization.

In general, the organization benefits through the leveraging of a database of information that is reasonably reflective of the skills within the organization. In the embodiments described above, this database of information is naturally updated through the participation of individuals within a collaborative work environment. Dedicated efforts of individuals to enable a yellow pages function is therefore not required.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method for identifying individuals in an organization, comprising:
receiving a request for identification of an individual having a desired type of experience;
searching an activity database for records that include information reflective of said desired type of experience;
creating a list of individuals that are associated with activity records identified in said search of said activity database; and
providing said created list of individuals to an originator of said request.

2. The method of claim 1, further comprising searching a database of training records for information reflective of said desired type of experience, wherein a training record for a particular individual includes information that identifies content of a training program that said particular individual has attended.

3. The method of claim 2, wherein said training program is an external training program.

4. The method of claim 2, wherein said training program is an internal training program.

5. The method of claim 4, wherein said training program is an on the job training program.

6. The method of claim 1, further comprising searching a database of profile records for information reflective of said desired type of experience, wherein a profile record for a particular individual includes information that summarizes professional experiences for said particular individual.

7. The method of claim 6, wherein said profile record is a personal resume.

8. The method of claim 1, wherein said searching comprises searching activity records that are generated to reflect work performed within an organization.

9. The method of claim 8, wherein said activity records are objects within an enterprise management system, said enterprise management system being responsible for coordinating work performed by a plurality of individuals in the organization.

10. The method of claim 9, wherein an activity record object includes a description attribute that describes an activity for which the activity record object represents.

11. The method of claim 10, wherein said activity record object further includes a competency index attribute that describes competencies that are used in the activity for which the activity record object represents.

12. The method of claim 1, wherein said searching comprises searching an activity metadatabase that is automatically derived from activity records that are generated to reflect work performed within an organization.

13. The method of claim 1, wherein said searching comprises searching using a search engine.

14. The method of claim 1, wherein said searching comprises searching for types of experiences within a set of predefined types of experience.

15. The method of claim 1, wherein said creating comprises creating a list that ranks individuals according to a proficiency metric for said desired type of experience.

16. The method of claim 1, wherein said creating comprises creating a list of individuals that includes performance ratings.

17. The method of claim 1, wherein said creating comprises creating a list of individuals that includes schedule availability information.

18. The method of claim 1, wherein an activity record in said activity database of records is one of a project, summary task, task, and workflow activity records.

19. A method for automatically generating a measure of user competency, comprising:
identifying an activity record descriptive of work, performed within an organization, with which a user has been involved, said work being unaffiliated with a user training program; and
determining based on analysis of said activity record a measure of user competency reflective of an involvement of said user in said work.

20. The method of claim 19, wherein said activity record includes a work description attribute that enables derivation of said measure of user competency.

21. The method of claim 19, wherein said activity record includes a competency index attribute that includes competency keyword values.

22. The method of claim 19, wherein said analysis includes identification of a competency.

23. The method of claim 19, wherein said analysis includes identification of a competency keyword in said activity record.

24. The method of claim 19, wherein said analysis includes a generation of metadatabase information.

25. The method of claim 24, wherein said analysis includes identification of a competency.

26. The method of claim 24, wherein said analysis includes identification of a competency qualifier.

27. The method of claim 19, further comprising accumulating measures of user competency that are determined from a plurality of activity records within which a user has been involved to generate a competency profile for said user.

28. The method of claim 27, further comprising updating said competency profile for said user by including newly determined measures of user competency from newly added activity records.

29. A method for leveraging existing skills within an organization, comprising:
searching an activity database for records that include information reflective of a desired type of experience, wherein said activity database includes records that are descriptive of past and current collaborative work that has been undertaken by individuals within the organization; and
creating a list of individuals that are associated with activity records identified in said search of said activity database.

30. The method of claim 29, further comprising searching a database of training records for information reflective of said desired type of experience, wherein a training record for a particular individual includes information that identifies content of a training program that said particular individual has attended.

31. The method of claim 29, further comprising searching a database of profile records for information reflective of said desired type of experience, wherein a profile record for a particular individual includes information that summarizes professional experiences for said particular individual.

32. The method of claim 29, wherein said activity records are objects within an enterprise management system, said enterprise management system being responsible for coordinating work performed by a plurality of individuals in the organization.

33. The method of claim 32, wherein an activity record object includes a description attribute that describes an activity for which the activity record object represents.

34. The method of claim 33, wherein said activity record object further includes a competency index attribute that describes competencies that are used in the activity for which the activity record object represents.

35. The method of claim 29, wherein said searching comprises searching using a search engine.

36. The method of claim 29, wherein said searching comprises searching for types of experiences within a set of predefined types of experience.

37. The method of claim 29, wherein an activity record in said activity database of records is one of a project, summary task, task, and workflow activity records.

38. The method of claim 29, wherein said creating comprises creating a list of individuals that includes performance ratings.

39. The method of claim 29, wherein said creating comprises creating a list of individuals that includes schedule availability information.

40. A computer program product, comprising:
computer-readable program code for causing a computer to receive a request for identification of an individual having a desired type of experience;
computer-readable program code for causing a computer to search an activity database for records that include information reflective of said desired type of experience;
computer-readable program code for causing a computer to create a list of individuals that are associated with activity records identified in said search of said activity database;
computer-readable program code for causing a computer to provide said created list of individuals to an originator of said request; and
a computer-usable medium configured to store the computer-readable program codes.

41. A computer program product, comprising:
computer-readable program code for causing a computer to identify an activity record descriptive of work, performed within an organization, with which a user has been involved, said work being unaffiliated with a user training program;
computer-readable program code for causing a computer to determine based on analysis of said activity record a measure of user competency reflective of an involvement of said user in said work; and
a computer-usable medium configured to store the computer-readable program codes.

42. A computer program product, comprising:
computer-readable program code for causing a computer to search an activity database for records that include information reflective of a desired type of experience, wherein said activity database includes records that are descriptive of past and current collaborative work that has been undertaken by individuals within the organization;
computer-readable program code for causing a computer to create a list of individuals that are associated with activity records identified in said search of said activity database; and
a computer-usable medium configured to store the computer-readable program codes.

43. An individual identification system, comprising:
an activity database, said activity database being configured to store records that are descriptive of past and current collaborative work that has been undertaken by individuals within the organization;
an individual identification component responsive to a request for identification of an individual having a desired type of experience, said individual identification component being configured to search said activity database for records that include information reflective of said desired type of experience and to create a list of individuals that are associated with activity records identified in said search.

44. A method for identifying competencies of individuals in an organization, comprising:
creating an activity record that is representative of work to be performed within an organization;
associating one or more participants with said created activity record; and
associating a competency profile with said created activity record, said competency profile enabling an assignment of competency credit for one or more competencies to said one or more participants that are associated with said created activity record.

45. The method of claim 44, wherein said activity record is an activity object.

46. The method of claim 44, wherein said created activity record is associated with one participant.

47. The method of claim 44, wherein said created activity record is associated with a plurality of participants.

48. The method of claim 44 wherein said competency profile enables an assignment of competency credit for one competency.

49. The method of claim 44 wherein said competency profile enables an assignment of competency credit for a plurality of competencies.
